(19) United States
(12) Patent Application Publication
(10) Pub. No.: US 2013/0083010 A1
(43) Pub. Date: Apr. 4, 2013

(54) THREE-DIMENSIONAL IMAGE PROCESSING APPARATUS AND THREE-DIMENSIONAL IMAGE PROCESSING METHOD

(71) Applicant: Kazuki KUWAHARA, Saitama-shi (JP)

(72) Inventor: Kazuki KUWAHARA, Saitama-shi (JP)

(73) Assignee: KABUSHIKI KAISHA TOSHIBA, Tokyo (JP)

(21) Appl. No.: 13/442,556

(22) Filed: Apr. 9, 2012

(30) Foreign Application Priority Data
Sep. 30, 2011 (JP) 2011-216839

(51) Int. Cl. G06T 15/00

(52) U.S. Cl. 345/419

(57) ABSTRACT

In one embodiment, a three-dimensional image processing apparatus includes: an imaging module configured to image a field including a front of a display, the display configured to display a three-dimensional image; a detection module configured to detect a face from an image imaged by the imaging module; and a controller configured to exclude a face detected by the detection module from a target for forming a visual field being a field where the three-dimensional image is recognizable as a three-dimensional body.

### CROSS-REFERENCE TO RELATED APPLICATION

This application is based upon and claims the benefit of priority from the prior Japanese Patent Application No. 2011-216839, filed on Sep. 30, 2011, the entire contents of which are incorporated herein by reference.

### FIELD

Embodiments described herein relate generally to a three-dimensional image processing apparatus and a three-dimensional image processing method.

### BACKGROUND

In recent years, image processors through which a three-dimensional image can be viewed (hereinafter, described as three-dimensional image processors) have been developed and released. Some three-dimensional image processors employ an integral imaging system (also called an integral photography system) in which pixels of a plurality of images having parallax (multi-view images) are discretely arranged in one image (hereinafter, described as a synthesized image) and orbits of light beams from pixels constituting the above synthesized image are controlled using a lenticular lens or the like to cause an observer to perceive a three-dimensional image, and a parallax barrier system in which slits are formed in one plate to limit the vision of an image.

In the integral imaging system and the parallax barrier system, by controlling the orbits of light beams, the position of a field where an image can be recognized as a three-dimensional body (hereinafter, simply described as a visual field) can be moved. For this reason, a conventional three-dimensional image processor has been proposed to include a camera, detect a face from an image imaged by the camera, and control orbits of light beams so that a visual field is formed at the position of the detected face.

### BRIEF DESCRIPTION OF THE DRAWINGS

FIG. 1 is a configuration diagram of a three-dimensional image processor according to an embodiment.

FIG. 2 is a view illustrating visual fields of the three-dimensional image processor according to an embodiment.

FIG. 3 is a view illustrating one example of an image displayed on a display screen.

FIG. 4 to FIG. 6 are flowcharts illustrating the operation of the three-dimensional image processor according to an embodiment.

### DETAILED DESCRIPTION

Hereinafter, an embodiment will be explained with reference to the drawings.

### Embodiment

A three-dimensional image processor (a three-dimensional image processing apparatus) according to an embodiment includes: an imaging module configured to image a field including a front of a display, the display configured to display a three-dimensional image; a detection module configured to detect a face from an image imaged by the imaging module; and a controller configured to exclude a face detected by the detection module from a target for forming a visual field being a field where the three-dimensional image is recognizable as a three-dimensional body.

### (Configuration of a Three-Dimensional Image Processing Apparatus 100)

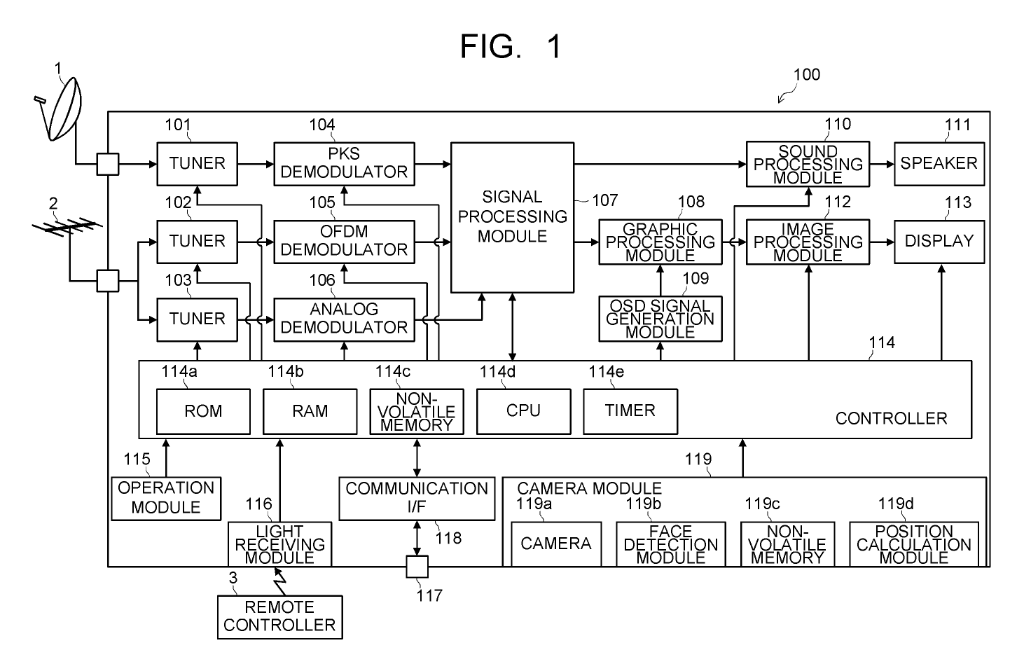

FIG. 1 is a configuration diagram of a three-dimensional image processing apparatus 100 (hereinafter, described as a three-dimensional image processor 100) according to an embodiment. The three-dimensional image processor 100 according to the embodiment includes: tuners 101 to 103; a PSK (Phase Shift Keying) demodulator 104; an OFDM (Orthogonal Frequency Division Multiplexing) demodulator 105; an analog demodulator 106; a signal processing modulemodule 107; a graphic processing modulemodule 108; an OSD (On Screen Display) signal generation modulemodule 109; a sound processing modulemodule 110; a speaker 111; an image processing modulemodule 112; a display 113; a controller 114; an operation modulemodule 115 (operation accepting module); a light receiving modulemodule 116 (operation accepting module); a terminal 117; a communication I/F (Inter Face) 118; and a camera module 119 (an imaging module, a face detection module, and a position calculation module).

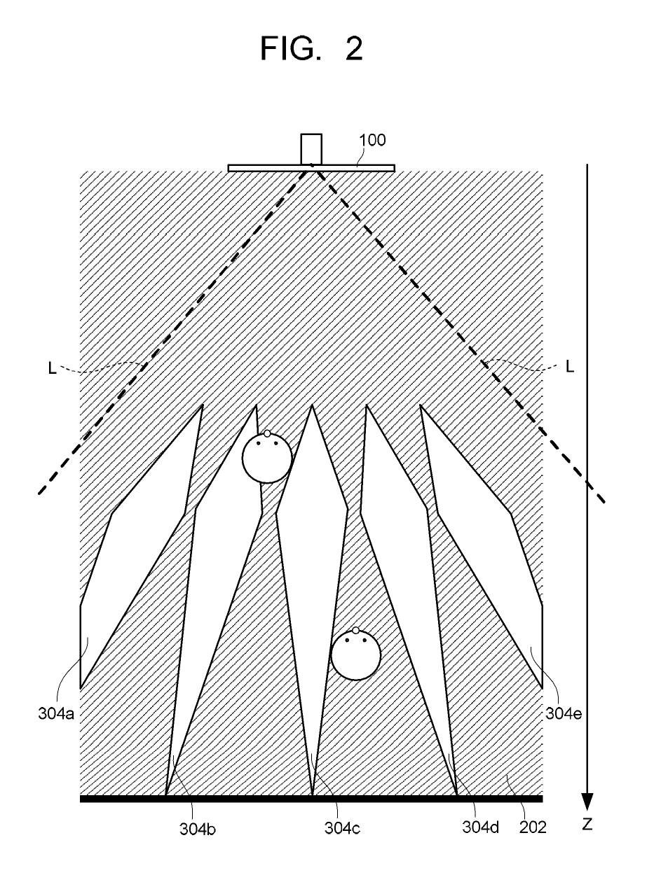

First, the outline of the three-dimensional image processor 100 will be explained. FIG. 2 is a view illustrating fields where an image displayed on the display of the three-dimensional image processor 100 can be recognized as a three-dimensional body, (each of which will be simply described as a visual field hereinafter). Broken lines L in FIG. 2 indicate the boundaries of the imaging range of a camera 119a. The three-dimensional image processor 100 is, for example, a digital television. The three-dimensional image processor 100 presents a three-dimensional image to a viewer (hereinafter, described as a user) by the integral imaging system of discretely arranging pixels of a plurality of images having parallax (multi-view images) in one image (hereinafter, described as a synthesized image), and controlling orbits of light beams from pixels constituting the above synthesized image using a lenticular lens or the like to cause an observer to perceive a three-dimensional image.

As illustrated in FIG. 2, in the three-dimensional image processor 100, a plurality of visual fields 304a to 304e are formed. In the integral imaging system, by controlling the orbits of light beams by the lenticular lens, the positions of the above visual fields 304a to 304e can be moved to the front and rear, and to the right and left with respect to the three-dimensional image processor 100. However, in the integral imaging system, the positions of a plurality of the visual fields 304a to 304e cannot be moved independently.

For this reason, when a face other than the user's face (a specific face), for example, a face photograph such as a poster, a wall pattern, an animal's face, or the like, is detected erroneously by the later-described camera module 119, there is caused a risk that a visual field is formed to match the position of the above face detected erroneously but a visual field is not formed for the user for whom a visual field should be formed originally.

Thus, the three-dimensional image processor 100 according to the embodiment is configured so that the user can set whether or not to exclude the face detected by the later-described camera module from a target for visual field formation. Further, the three-dimensional image processor 100 also recommends excluding the face whose position has not changed for a certain time period (for example, several hours) from the target for the visual field formation because it is highly possible that a face photograph such as a poster, or the like has been detected erroneously. Further, the three-dimensional image processor 100 stores facial features of animals and the like registered previously and compares feature points of the detected face with the stored facial features to thereby perform more particular face recognition, and also in the case when a comparison result is in excess of a certain threshold value, the three-dimensional image processor 100 recommends excluding the detected face from the target for the visual field formation. Note that in FIG. 2, the case where the number of visual fields is five is illustrated, but the number of visual fields is not limited to five.

### (Details of the Respective Components)

The tuner 101 selects a broadcast signal of a desired channel from satellite digital television broadcasting received by an antenna 1 for receiving BS/CS digital broadcasting, based on a control signal from the controller 114. The tuner 101 outputs the selected broadcast signal to the PSK demodulator 104. The PSK demodulator 104 demodulates the broadcast signal input from the tuner 101 and outputs the demodulated broadcast signal to the signal processing module 107, based on a control signal from the controller 114.

The tuner 102 selects a digital broadcast signal of a desired channel from terrestrial digital television broadcast signals received by an antenna 2 for receiving terrestrial broadcasting, based on a control signal from the controller 114. The tuner 102 outputs the selected digital broadcast signal to the OFDM demodulator 105. The OFDM demodulator 105 demodulates the digital broadcast signal input from the tuner 102 and outputs the demodulated digital broadcast signal to the signal processing module 107, based on a control signal from the controller 114.

The tuner 103 selects an analog broadcast signal of a desired channel from terrestrial analog television broadcast signals received by the antenna 2 for receiving terrestrial broadcasting, based on a control signal from the controller 114. The tuner 103 outputs the selected analog broadcast signal to the analog demodulator 106. The analog demodulator 106 demodulates the analog broadcast signal input from the tuner 103 and outputs the demodulated analog broadcast signal to the signal processing module 107, based on a control signal from the controller 114.

The signal processing module 107 generates an image signal and a sound signal from the demodulated broadcast signals input from the PSK demodulator 104, the OFDM demodulator 105, and the analog demodulator 106. The signal processing module 107 outputs the image signal to the graphic processing module 108, and outputs the sound signal to the sound processing module 110.

The OSD signal generation module 109, based on a control signal from the controller 114, generates an OSD signal and outputs the OSD signal to the graphic processing module 108.

The graphic processing module 108 generates a plurality of pieces of image data (multi-view image data) corresponding to two parallaxes or nine parallaxes from the image signal output from the signal processing module 107 based on a control signal from the controller 114. The graphic processing module 108 discretely arranges pixels of the generated multi-view images in one image to convert the image into a synthesized image having two parallaxes or nine parallaxes. The graphic processing module 108 outputs the OSD signal generated by the OSD signal generation module 109 to the image processing module 112.

The image processing module 112 converts the synthesized image converted by the graphic processing module 108 into a format that can be displayed on the display 113. The image processing module 112 outputs the converted synthesized image to the display 113 to cause it to display a three-dimensional image. The image processing module 112 converts the input OSD signal into a format that can be displayed on the display 113. The image processing module 112 outputs the converted OSD signal to the display 113 to cause it to display an image corresponding to the OSD signal.

The display 113 is a display for displaying a three-dimensional image of the integral imaging system including the lenticular lens for controlling the orbits of light beams from the pixels.

The sound processing module 110 converts the input sound signal into a format that can be reproduced by the speaker 111. The sound processing module 110 outputs the converted sound signal to the speaker 111 to cause it to reproduce sound.

On the operation module 115, a plurality of operation keys (for example, a cursor key, a decision (OK) key, a BACK (return) key, and color keys (red, green, yellow, and blue)) for operating the three-dimensional image processor 100 are arranged. The user depresses the above-described operation key, and thereby an operation signal corresponding to the depressed operation key is output to the controller 114.

The light receiving module 116 receives an infrared signal transmitted from a remote controller 3 (hereinafter, described as a controller 3). On the controller 3, a plurality of operation keys (for example, a cursor key, a decision (OK) key, a BACK (return) key, and color keys (red, green, yellow, and blue)) for operating the three-dimensional image processor 100 are arranged. The user depresses the above-described operation key, and thereby an infrared signal corresponding to the depressed operation key is emitted. The light receiving module 116 receives the infrared signal emitted from the controller 3. The light receiving module 116 outputs an operation signal corresponding to the received infrared signal to the controller 114.

The user can cause the three-dimensional image processor 100 to perform various operations and set functions of the three-dimensional image processor 100 by operating the above-described operation module 115 or controller 3. The user can set, for example, the number of parallaxes, auto-tracking, exclusion registration/cancellation, and auto-exclusion of the three-dimensional image processor 100.

### (Setting of the Number of Parallaxes)

For the setting of the number of parallaxes, the user can select whether to view the three-dimensional image with two parallaxes or nine parallaxes. The setting of the number of parallaxes selected by the user is stored in a later-described non-volatile memory 114c of the controller 114. The above-described number of parallaxes (two parallaxes or nine parallaxes) is one example, and another number of parallaxes (for example, four parallaxes or six parallaxes) may also be employed.

### (Setting of the Auto-Tracking)

For the setting of the auto-tracking, the user can set whether to turn ON or OFF the auto-tracking. When the setting of the auto-tracking is ON, the visual fields are automatically formed at the positions of the faces detected by the camera module 119 (from which the face excluded from the target for the later-described visual field formation is excluded). When the setting of the auto-tracking is ON, the faces are detected by the camera module 119 every predetermined time period (for example, several tens of seconds to several minutes), and the visual fields are formed at the positions of the above detected faces (from which the face excluded from the target for the later-described visual field formation is excluded). In the case when the setting of the auto-tracking is OFF, when the user operates the operation module 115 or the controller 3 to direct the formation of the visual field, the visual fields are formed at the positions of the faces detected by the camera module 119 (from which the face excluded from the target for the later-described visual field formation is excluded).

The formation of the visual field is performed as follows. For example, when the visual field is desired to be moved in the front-rear direction of the display 113, the visual field is moved in the front-rear direction of the display 113 by increasing or decreasing a display image and an aperture of an opening portion of the lenticular lens. When the aperture of the opening portion of the lenticular lens is increased, the visual field is moved to the rear of the display 113. When the aperture of the opening portion of the lenticular lens is decreased, the visual field is moved to the front of the display 113.

When the visual field is desired to be moved in the right-left direction of the display 113, the visual field is moved in the right-left direction of the display 113 by shifting the display image to the right and left. The visual field is moved to the left side of the display 113 by shifting the display image to the left. The visual field is moved to the right side of the display 113 by shifting the display image to the right.

### (Setting of the Exclusion Registration/Cancellation)

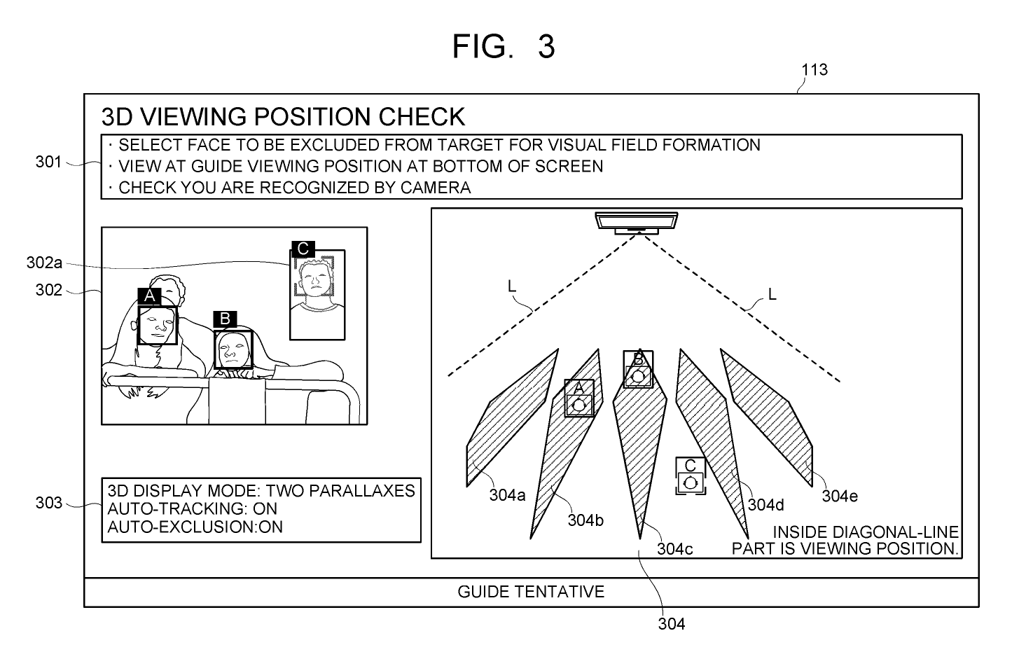

For the setting of the exclusion registration/cancellation, it is possible to set whether or not to exclude the face detected by the camera module 119 from the target for the visual field formation. When the detected face is registered as the target for exclusion, in the case when the setting of the auto-tracking is ON, or the user directs the formation of the visual field, the detected face is excluded from the target for forming the visual field. The registration of the detected face as the target for exclusion can be cancelled. When the registration is cancelled, the detected face is not excluded from the target for the visual field formation. That is, the detected face becomes the target for the visual field formation. The operation of the above exclusion registration/cancellation will be described later with reference to FIG. 3.

### (Setting of the Auto-Exclusion)

For the setting of the auto-exclusion, it is possible to set whether or not to automatically exclude the face recommended to be excluded by the controller 114 from the target for the visual field formation. When the setting of the auto-exclusion is ON, the face recommended to be excluded by the later-described controller 114 is automatically excluded from the target for the visual field formation. When the face recommended to be excluded has been automatically excluded from the target for the visual field formation, the user is notified that the face has been excluded. When the setting of the auto-exclusion is OFF, the user is notified whether or not the face recommended to be excluded by the later-described controller 114 is excluded from the target for the visual field formation. The user operates the operation module 115 or the controller 3 to decide whether or not to exclude the face recommended to be excluded from the target for the visual field formation.

The terminal 117 is a USB terminal, a LAN terminal, an HDMI terminal, an iLINK terminal, or the like for connecting an external terminal (for example, a USB memory, a DVD storage and reproduction device, an Internet server, or a PC).

The communication I/F 118 is a communication interface with the above-described external terminal connected to the terminal 117. The communication I/F 118 converts a control signal and a format of data and so on between the controller 114 and the above-described external terminal.

The camera module 119 is provided on the lower front side or the upper front side of the three-dimensional image processor 100. The camera module 119 includes: the camera 119a (imaging module); a face detection module 119b (the face detection module); a non-volatile memory 119c; and a position calculation module 119d (the position calculation module). The camera 119a is, for example, a CMOS (Complementary Metal Oxide Semiconductor) image sensor or a CCD (Charge Coupled Device) image sensor. The camera 119a images a field including the front of the three-dimensional image processor 100.

The face detection module 119b detects the face from the image imaged by the camera 119a. The face detection module 119b provides a unique number (Identification Data) for the detected face. For the above face detection, a known method can be used. For example, the algorithms of the face recognition can be roughly classified into a method of directly geometrically comparing visual features and a method of statistically digitizing the image and comparing the numeric value with a template. Either algorithm may also be used to detect the face in this embodiment.

The position calculation module 119d calculates position coordinates of the face detected by the face detection module 119b. For the above calculation of the position coordinates of the user, a known method can be used. For example, the position coordinates of the user whose face has been detected may also be calculated based on the distance between the right eye and the left eye of the face detected by the face detection module 119b and the coordinates from the center of the imaged image to the face center (the middle between the right eye and the left eye).

From the distance from the right eye to the left eye of the face, the distance from the camera 119a to the user can be calculated. Normally, the distance between the right eye and the left eye of a human being is about 65 mm, so that if the distance between the right eye and the left eye is found, the distance from the camera 119a to the detected face can be calculated. Further, from the position of the face in the imaged image and the above-described calculated distance, the position of the detected face in the top-down direction and in the right-left direction (an x-y plane) can be calculated.

The position calculation module 119d provides the same ID as the ID provided by the face detection module 119b, to data on the calculated position coordinates. The position coordinates are only needed to be recognized as three-dimensional coordinate data, and may also be expressed by any one of generally-known coordinate systems (for example, orthogonal coordinate system, polar coordinate system, and spherical-coordinate system).

When the face has been detected, the camera module 119 outputs the position coordinates calculated by the position calculation module 119d together with the ID provided by the face detection module 119b. Note that the face detection and the calculation of the position coordinates of the detected face may also be performed in the controller 114.

The controller 114 includes: a ROM (Read Only Memory) 114a; a RAM (Random Access Memory) 114b; the non-volatile memory 114c; and a CPU 114d. In the ROM 114a, a control program executed by the CPU 114d is stored. The RAM 114b serves as a work area for the CPU 114d. In the non-volatile memory 114c, various kinds of setting information (for example, the settings of the above-described number of parallaxes, tracking, exclusion registration/cancellation, and auto-exclusion), visual field information, facial features of animals, and so on are stored. The visual field information is the distribution of the visual field in the actual space made into three-dimensional coordinate data. The visual field information for the two parallaxes and the nine parallaxes is stored in the non-volatile memory 114c.

The controller 114 controls the three-dimensional image processor 100. Concretely, the controller 114 controls the operation of the three-dimensional image processor 100 based on the operation signals input from the operation module 115 and the light receiving module 116, and the setting information stored in the non-volatile memory 114c. Hereinafter, representative functions of the controller 114 will be described.

### (Control of the Number of Parallaxes)

When the number of parallaxes stored in the non-volatile memory 114c is two (parallaxes), the controller 114 instructs the graphic processing module 108 to generate image data for the two parallaxes from the image signal output from the signal processing module 107. When the number of parallaxes stored in the non-volatile memory 114c is nine (parallaxes), the controller 114 instructs the graphic processing module 108 to generate image data for the nine parallaxes from the image signal output from the signal processing module 107.

### (Control of the Tracking)

When the auto-tracking stored in the non-volatile memory 114c is ON, the controller 114 controls the orbits of light beams from the pixels of the display 113 so that the visual fields are formed at the positions of the faces detected by the camera module 119 (from which the face excluded from the target for the visual field formation is excluded) every predetermined time period (for example, several tens of seconds to several minutes). In the case when the auto-tracking stored in the non-volatile memory 114c is OFF, when the user operates the operation module 115 or the controller 3 to direct the formation of the visual field, the controller 114 controls the orbits of light beams from the pixels of the display 113 so that the visual fields are formed at the positions of the faces detected by the camera module 119 (from which the face excluded from the target for the visual field formation is excluded).

The controller 114 controls the lenticular lens so that all the faces to be the target for the visual field formation are located within the visual fields. However, when all the faces being the target for the visual field formation are not located within the visual fields, the controller 114 controls the lenticular lens so that the number of faces that are not located within the visual fields is minimized. When there exists the face that is not located within the visual fields, the controller 114 causes the display 113 to display that there exists the face that is not located within the visual fields to notify the user.

### (Detection of the Exclusion Recommendation)

The controller 114 detects the face that is preferably considered to be excluded from the target for the visual field formation from the faces detected by the camera module 119. The controller 114 detects the face whose position has not changed for a predetermined time period (for example, several hours) and the face that has been judged not to be the face of a human being by the result of a comparison with the facial features of animals previously stored in the non-volatile memory 114c, as the exclusion recommendation with respect to the visual field formation. The controller 114 measures the time period by using a timer 114e housed therein.

When the setting of the auto-exclusion is ON, the controller 114 automatically excludes the face detected as the exclusion recommendation from the target for the visual field formation. When the setting of the auto-exclusion is OFF, the controller 114 notifies the user whether or not to exclude the face detected as the exclusion recommendation from the target for the visual field formation. The user operates the operation module 115 or the controller 3 to decide whether or not to exclude the face recommended to be excluded, from the target for the visual field formation.

### (Display of an Exclusion Registration/Cancellation Screen)

When the exclusion recommendation has been detected by the controller 114, or the blue color key on the operation module 115 or the controller 3 has been depressed by the user, the controller 114 instructs the OSD signal generation module 109 to generate an OSD signal that displays an image illustrated in FIG. 3. The OSD signal generated by the OSD signal generation module 109 is displayed on the display 113 as the image illustrated in FIG. 3. In this embodiment, the blue color key is assigned to the operation of displaying the image illustrated in FIG. 3, but the different operation key may also be assigned. It is also possible that a menu screen is displayed on the display 113, and the exclusion registration/cancellation screen is selected on the above menu screen, and then the decision key is depressed, and thereby the image illustrated in FIG. 3 is displayed on the display 113.

FIG. 3 is an image view displayed on the display 113. As illustrated in FIG. 3, display frames 301 to 304 are displayed on the display 113. Hereinafter, images displayed in the respective display frames 301 to 304 will be explained.

### (Display Frame 301)

In the display frame 301, the direction of the exclusion registration and items required for the user to view the three-dimensional image inside a field where the user can recognize the image as a three-dimensional body, namely, the visual field are displayed.

### (Display Frame 302)

In the display frame 302, an image imaged by the camera 119a of the camera module 119 is displayed. The user can check the orientation and the position of the face and whether or not the face has been actually detected, and the like, from the image displayed in the display frame 302. The detected face is surrounded by a frame. In an upper portion on the frame, the ID (an alphabet in this embodiment) that has been provided by the face detection module 119b of the camera module 119 is displayed.

### (Setting of the Exclusion Registration/Cancellation)

The user can set whether or not to exclude the detected face from the target for the visual field formation by operating the operation module 115 or the controller 3. The user operates the cursor key to select the face that the user sets as the target for exclusion or the face of which the user cancels the registration as the target for exclusion, from the image displayed in the display frame 302. When the user operates the cursor key, in the display frame 302, the frame surrounding the face being selected currently is highlighted (for example, the frame is displayed in a blinking manner, or the frame is displayed boldly).

The user selects the face that the user sets as the target for exclusion or the face of which the user cancels the registration as the target for exclusion, and then depresses the decision key. Every time the user depresses the decision key, the exclusion registration and the cancellation of the exclusion registration (hereinafter, described as exclusion cancellation) of the selected face change alternately (cyclically). That is, if the setting is the exclusion registration, by depressing the decision key, the setting changes to the exclusion cancellation. If the setting is the exclusion cancellation, by depressing the decision key, the setting changes to the exclusion registration.

The frame displayed in the display frame 302 changes in color depending on the setting state of the face surrounded by the frame (hereinafter, described as a status). In Table 1 below, the relationship between the color of the frame displayed in the display frame 302 and the status is illustrated.

TABLE 1

| COLOR OF | EXCLUSION | EXCLUSION |
|---|---|---|
| FRAME | REGISTRATION | RECOMMENDATION |
| BLUE | NO | NO |
| YELLOW | NO | YES |
| RED | YES | |

The color of the frame displayed in the display frame 302 changes depending on whether or not the face surrounded by the frame has been registered to be excluded and whether or not the face surrounded by the frame has been recommended to be excluded, as illustrated in Table 1. When the color of the frame is blue, the state where the exclusion registration of the face has been cancelled and further the face has not been recommended to be excluded is indicated. When the color of the frame is yellow, the state where the exclusion registration of the face has been cancelled and further the face has been recommended to be excluded is indicated. When the color of the frame is red, the state where the face has been registered to be excluded is indicated.

For example, in the example illustrated in FIG. 3, as for the face in a frame “C, ” the face drawn on a poster 302a has been detected erroneously. In the above case, the position of the face has not changed for a predetermined time period, so that the face is detected as the exclusion recommendation by the controller 114. For this reason, if the user has registered the face in the frame “C” to be excluded, the color of the frame “C” is displayed in red, and if the exclusion registration of the face has been cancelled, the color of the frame “C” is displayed in yellow.

The allocation of the color to each of the statuses illustrated in Table 1 is one example, and can be changed appropriately. The statuses may also be shown not in colors but by shapes (for example, circle, triangle, and quadrangle) of frames.

The display form of the frame is displayed differently depending on whether or not the face is located inside the visual field. When the face is located inside the visual field, the frame surrounding the face is drawn by a solid line. When the face is located outside the visual field, the frame surrounding the face is drawn by a broken line. In the example illustrated in FIG. 3, it is found that the faces in frames “A” and “B” are located inside the visual fields and the face in the frame “C” is located outside the visual field.

When the face is located outside the visual field, the user cannot recognize the image as a three-dimensional body due to occurrence of so-called reverse view, crosstalk, or the like. However, in this embodiment, the display form of the frame is different depending on whether or not the face is located inside the visual field. For this reason, the user can easily check whether his/her position is inside or outside the visual field. In the example illustrated in FIG. 3, the kind of the line (solid line, broken line) of the frame surrounding the face is made different depending on whether or not the position of the face is inside the visual field. However, other display forms, for example, the shape (quadrangle, triangle, circle, or the like), the color, and the like of the frame may also be made different depending on whether or not the position of the face is inside the visual field. Even in this manner, the user can easily check whether his/her position is inside or outside the visual field.

Whether or not the position of the face is inside the visual field is judged based on the position coordinates of the face that are calculated by the position calculation module 119d and the visual field information stored in the non-volatile memory 114c. In this event, the controller 114 changes the visual field information referred to depending on whether the setting of the number of parallaxes is two parallaxes or nine parallaxes. That is, the controller 114 refers to the visual field information for two parallaxes when the setting of the number of parallaxes is two parallaxes. The controller 114 refers to the visual field information for nine parallaxes when the setting of the number of parallaxes is nine parallaxes.

In the display frame 303, the current setting information is displayed. Concretely, whether the number of parallaxes of the three-dimensional image is two parallaxes or nine parallaxes, whether the auto-tracking is ON or OFF, and whether the auto-exclusion is ON or OFF are displayed.

In the display frame 304, there are displayed visual fields 304a to 304e (diagonal-line parts) each being a field where the image can be viewed in three dimensions, and position information (icons indicating faces and frames surrounding the icons) of the faces that is calculated by the position calculation module 119d of the camera module 119, and IDs (alphabets), as a bird's eye view. The bird's eye view displayed in the display frame 304 is displayed based on the visual field information stored in the non-volatile memory 114c and the position coordinates of the faces calculated by the position calculation module 119d.

The color and shape of the frame surrounding the icon are linked to the color and shape of the frame displayed in the display frame 302. For this reason, the frame to which the same ID has been provided is displayed in the same color and shape in the display frame 302 and the display frame 304. For example, if the frame “A” in the display frame 302 is displayed in red and by a solid line, the frame “A” in the display frame 304 is also displayed in red and by a solid line. By referring to the bird's eye view and the position information displayed in the display frame 304, the user can easily understand whether or not his or her face has been detected. Further, when his or her face has been detected, the user can easily understand the status of the face and whether or not the face is located inside the visual field. In FIG. 3, although the same alphabet is displayed for the same user, the same user may also be indicated by another method, for example, the color or the shape of the frame.

Broken lines L in the display frame 304 indicate the boundaries of the imaging range by the camera 119a. That is, the range actually imaged by the camera 119a and displayed inside the display frame 302 is a range on the lower side of the broken lines L. For this reason, display of an upper left range and an upper right range from the broken lines L inside the display frame 304 may also be omitted in the display frame 304.

### (Update of the Visual Field Information)

The controller 114 recalculates the position (distribution) of a new visual field every time the visual field is changed by the auto-tracking or the operation by the user, and updates the visual field information stored in the non-volatile memory 114c.

### (Operation of the Three-Dimensional Image Processor 100)

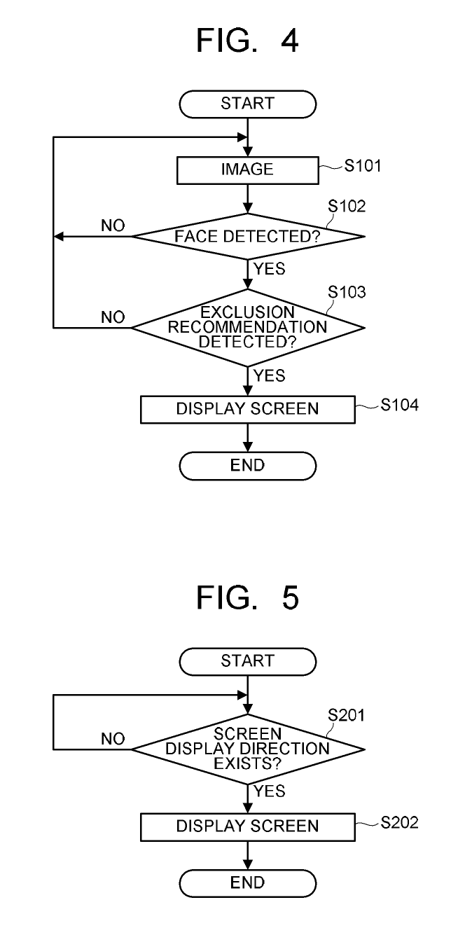

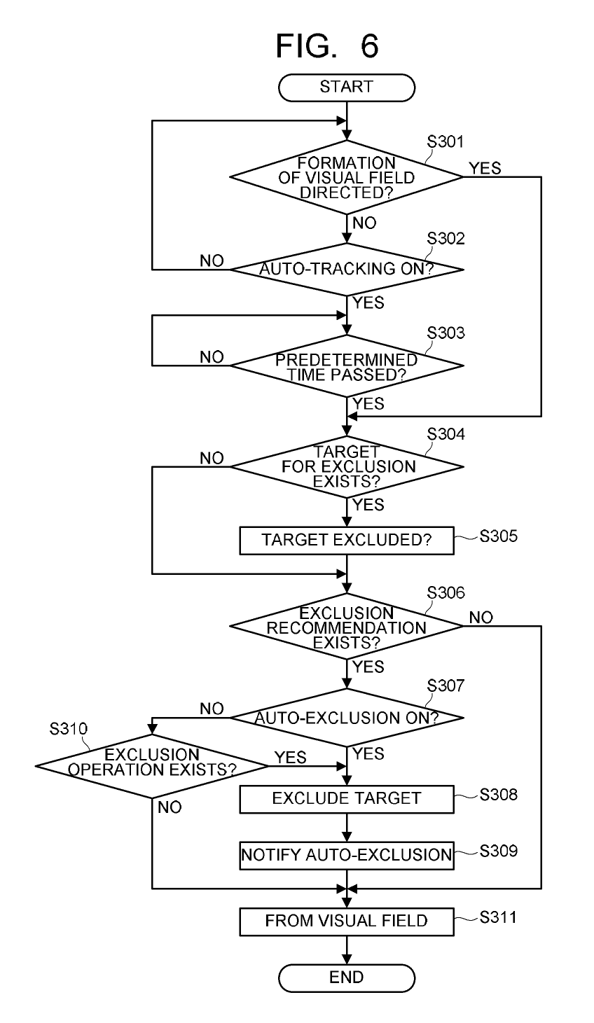

FIG. 4 and FIG. 5 are a flowchart illustrating the operation of displaying the exclusion registration/cancellation screen of the three-dimensional image processor 100. FIG. 6 is a flowchart illustrating the operation of forming the visual field of the three-dimensional image processor 100. Hereinafter, the operation of the three-dimensional image processor 100 will be explained with reference to FIG. 4 to FIG. 6.

### (Operation of Displaying the Exclusion Registration/Cancellation Screen)

With reference to FIG. 4 and FIG. 5, the operation of displaying the exclusion registration/cancellation screen will be explained. FIG. 4 is the flowchart illustrating the operation in the case when the exclusion recommendation is detected. FIG. 5 is the flowchart illustrating the operation in the case when the user operates the operation module 115 or the controller 3.

### (Case When the Exclusion Recommendation is Detected)

First, with reference to FIG. 4, the operation in the case when the exclusion recommendation is detected will be explained. The camera module 119 images the front of the three-dimensional image processor 100 by the camera 119a (Step S101). The face detection module 119b detects the face from the image imaged by the camera 119a (Step S102). When the face has not been detected (No at Step S102), the three-dimensional image processor 100 returns to the operation at Step S101.

When the face has been detected by the face detection module 119b (Yes at Step S102), the controller 114 judges whether or not the face detected by the face detection module 119b becomes the target for the exclusion recommendation (Step S103). The controller 114 detects the face whose position has not changed for a predetermined time period (for example, several hours) and the face that has been judged not to be the face of a human being by the result of a comparison with the facial features of animals previously stored in the non-volatile memory 114c as the exclusion recommendation. The controller 114 measures the time period by using the timer 114e.

When the face to be the exclusion recommendation has been detected (Yes at Step S103), the controller 114 instructs the OSD signal generation module 109 to generate the OSD signal of the exclusion registration/cancellation screen illustrated in FIG. 3 to output the OSD signal. When the face to be the exclusion recommendation has not been detected (No at Step S103), the three-dimensional image processor 100 returns to the operation at Step S101.

The OSD signal generation module 109 generates the OSD signal in FIG. 3 based on the instruction from the controller 114 to output the OSD signal to the image processing module 112 via the graphic processing module 108. The image processing module 112 converts the OSD signal from the OSD signal generation module 109 into a format that can be displayed on the display 113 to output it to the display 113. On the display 113, the image illustrated in FIG. 3 is displayed (Step S104).

### (Case by the User's Operation)

Next, with reference to FIG. 5, the operation in the case when the display of the exclusion registration/cancellation screen is directed by the user's operation will be explained. The controller 114 judges whether or not the user has directed the display of the exclusion registration/cancellation screen illustrated in FIG. 3 (Step S201). Whether or not the user has directed the display of the exclusion registration/cancellation screen can be judged by the operation signal from the operation module 115 or the light receiving module 116.

When the display of the exclusion registration/cancellation screen has been directed (Yes at Step S201), the controller 114 instructs the OSD signal generation module 109 to generate the OSD signal of the exclusion registration/cancellation screen illustrated in FIG. 3 to output the OSD signal. When the display of the exclusion registration/cancellation screen has not been directed (No at Step S201), the three-dimensional image processor 100 returns to the operation at Step S201.

The OSD signal generation module 109 generates the OSD signal in FIG. 3 based on the instruction from the controller 114 to output the OSD signal to the image processing module 112 via the graphic processing module 108. The image processing module 112 converts the OSD signal from the OSD signal generation module 109 into a format that can be displayed on the display 113 to output it to the display 113. On the display 113, the image illustrated in FIG. 3 is displayed (Step S202).

### (Operation of Forming the Visual Field)

Next, the operation of forming the visual field will be explained with reference to FIG. 6. When the user has operated the operation module 115 or the controller 3 to direct the formation of the visual field (Yes at Step S301), or the setting of the auto-tracking mode is ON (Yes at Step S302) and a predetermined time interval has passed (Yes at Step S303), the controller 114 detects whether or not there exists the face registered as the target for exclusion with respect to the faces detected by the camera module 119 (Step S304).

When there exists the face registered as the target for exclusion (Yes at Step S304), the controller 114 excludes the face registered as the target for exclusion from the target for the visual field formation (Step S305). Further, when there does not exist the face registered as the target for exclusion (No at Step S304), a control module 114 executes the operation at Step S306.

Next, the controller 114 detects whether or not there exists the face corresponding to the exclusion recommendation with respect to the faces detected by the camera module 119 (Step S306). When there exists the face corresponding to the exclusion recommendation (Yes at Step S306), the controller 114 checks whether or not the setting of the auto-exclusion is ON (Step S307). When the setting of the auto-exclusion is ON (Yes at Step S307), the controller 114 excludes the face corresponding to the exclusion recommendation from the target for the visual field formation (Step S308). Further, when there does not exist the face corresponding to the exclusion recommendation (No at Step S306), the control module 114 executes the operation at Step S311.

The controller 114 notifies that the face recommended to be excluded has been excluded from the target for the visual field formation (Step S309). The above notification is provided in a manner that for example, the image imaged by the camera module 119 is displayed on the display 113 and the face excluded from the target for the visual field formation is highlighted (for example, surrounded by a frame).

When the setting of the auto-exclusion is OFF (No at Step S307), the controller 114 judges whether or not there exists the face that has been excluded from the target for the visual field formation by the user with respect to the face recommended to be excluded (Step S310). When there exists the excluded face (Yes at Step S310), the controller 114 executes the operations at and after Step S308 (including the operation at Step S308). When there does not exist the excluded face (No at Step S310), the controller 114 executes the operation at Step S311.

The controller 114 controls the lenticular lens provided in the display 113 to form the visual fields at the positions of the faces detected by the camera module 119 (from which the face/faces excluded from the target for the visual field formation is/are excluded) (Step S311). When the visual fields are formed, the lenticular lens is controlled so that all the faces to be the target for the visual field formation are located inside the visual fields, but when all the faces being the target for the visual field formation are not located inside the visual fields, the controller 114 controls the lenticular lens so that the number of faces that are not located within the visual fields is minimized. When there exists the face that is not located within the visual fields, the controller 114 causes the display 113 to display that there exists the face that is not located within the visual fields to notify the user.

As above, in the three-dimensional image processor 100 according to the embodiment, when the face to be the exclusion recommendation has been detected, or the user has operated the operation module 115 or the controller 3 to direct the display of the exclusion registration/cancellation screen, the exclusion registration/cancellation screen illustrated in FIG. 3 is displayed on the display 113. The user can set whether or not to exclude the detected face from the target for the visual field formation while checking the face displayed in the display frame 302 in FIG. 3. The user can exclude the face detected erroneously, for example, the poster, the wall pattern, the animal's face, and so on from the target for the visual field formation so that the visual field is formed for the user for whom the visual field should be formed originally.

Since the face whose position has not changed for a certain time period (for example, several hours) and the face that has been judged not to be the face of a human being by the result of a comparison with the facial features of animals previously stored in the non-volatile memory 114c are detected as the exclusion recommendation, the convenience for the user is improved. Further, when the auto-exclusion is set to ON, the face detected as the exclusion recommendation is automatically excluded from the target for the visual field formation, and thus the convenience for the user is improved.

Further, in the display frame 302 of a viewing position check screen, the image imaged by the camera module 119 is displayed, and the detected faces of the users are each surrounded by a frame. The display form of the above frame (for example, the shape (quadrangle, triangle, circle, or the like), the color, or the kind of the line (solid line, broken line, or the like) of the frame) is different depending on the status, so that the user can easily get to know the status of each of the faces. Consequently, the convenience for the user is improved.

In the display frame 303 of the viewing position check screen, the current setting information is displayed. Thus, the user can easily get to know the current setting status.

Furthermore, in the display frame 304 of the viewing position check screen, the visual fields 304a to 304e (diagonal-line parts) each being a field where the three-dimensional image can be viewed in three dimensions, and the position information (the icons and the frames surrounding the icons) of the users that is calculated by the position calculation module 119d of the camera module 119 are displayed as a bird's eye view. For the position information of each of the faces, the ID provided thereto is displayed in the upper portion. Since the display form of the frame surrounding the icon of the face (for example, the shape (quadrangle, triangle, circle, or the like), the color, or the kind of the line (solid line, broken line, or the like) of the frame) is different depending on the status of the face, the user can easily get to know the status of each of the faces. Consequently, the convenience for the user is improved.

Further, in the image displayed in the display frame 302 and the bird's eye view displayed in the display frame 304, the same ID is displayed for the same face, and thus, even when a plurality of users, that is, viewers exist, the individual user can easily understand the position where the user is located.

Although the three-dimensional image processor 100 has been explained, for example, taking the digital television as an example in the above-described embodiment, the present invention is applicable to devices that present a three-dimensional image to the user (for example, a PC (Personal computer), a cellular phone, a tablet PC, a game machine, and the like) and a signal processor that outputs an image signal to a display that presents a three-dimensional image (for example, an STB (Set Top Box)).

Although the relation between the visual field and the position of the user is presented to the user as a bird's eye view (see FIG. 3) in the above-described embodiment, any view other than the bird's eye view may also be employed as long as the positional relation between the visual field and the position of the user can be understood. Further, although the face of the user is detected and the position information of the user is calculated in the above-described embodiment, other methods may also be used to detect the user. In this event, for example, a part other than the face of the user (for example, the shoulder, the upper body, or the like of the user) may also be detected.

### (Other Embodiments)

While certain embodiments have been described, these embodiments have been presented by way of example only, and are not intended to limit the scope of the inventions. Indeed, the novel embodiments described herein may be embodied in a variety of other forms; furthermore, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image processing apparatus, comprising:
an imaging module configured to capture a field including a front of a display, the display configured to display a three-dimensional image;
a detectionmodule configured to detect a face from an image captured by the imaging module; and
a controller configured to determine whether to exclude the face detected by the detection module from a target for forming a visual field where the three-dimensional image is recognizable as a three-dimensional body.

2. The apparatus of claim 1,
wherein, when receiving a signal to exclude the face detected by the detection module from the target for forming the visual field, the controller excludes the detected face from the target for forming the visual field.

3. The apparatus of claim 1,
wherein, when the face detected by the detectionmodule corresponds to a specific face, the controller excludes the face corresponding to the specific face from the target for forming the visual field.

4. The apparatus of claim 1,
wherein, when receiving a signal to cancel the exclusion, the controller sets the face that has been excluded from the target for forming the visual field as the target for forming the visual field.

5. The apparatus of claim 3, further comprising a memory configured to store features of the specific face,
wherein the controller judges whether the face detected by the detection module corresponds to the specific face based on a comparison of features of the face detected by the detection module and the features of the face that are stored in the memory.

6. The apparatus of claim 3,
wherein the controller excludes the face that is detected by the detection module and whose position has not changed for a predetermined time period from the target for forming the visual field as the specific face.

7. The apparatus of claim 1,
wherein the controller notifies a user that a position of the face detected by the detection module has not changed for a predetermined time period.

8. The apparatus of claim 1,
wherein, when the controller has excluded the face from the target for forming the visual field, the controller notifies a user that the face has been excluded.

9. The apparatus of claim 1, further comprising a position calculation module configured to calculate a position of the face detected by the detection module,
wherein the controller controls the display to display position information indicating the calculated position of the face on a first image showing the visual field in a different display form depending on whether the face has been excluded from the target for the visual field.

10. The apparatus of claim 1, wherein the controller controls the display to display an image captured by the imaging module in a different display form depending on whether the face has been excluded from the target for the visual field.

11. A three-dimensional image processing apparatus, comprising:
an imaging module configured to capture a field including a front of a display, the display being configured to display a three-dimensional image;
a detectionmodule configured to detect a face from an image captured by the imaging module; and
a selection module configured to exclude the face detected by the detection module from a target for forming a visual field where the three-dimensional image is recognizable as a three-dimensional body.

12. A three-dimensional image processing method, comprising:
detecting a face from an image of a field including a front of a display that displays a three-dimensional image; and
excluding the detected face from a target for forming a visual field where the three-dimensional image is recognizable as a three-dimensional body.
